(19) United States
(12) Patent Application Publication
(10) Pub. No.: US 2013/0266845 A1
(43) Pub. Date: Oct. 10, 2013

(54) BATTERY

(71) Applicant: MITSUBISHI HEAVY INDUSTRIES, LTD., Tokyo (JP)

(72) Inventors: Yoshiaki Kanda, Tokyo (JP); Miki Kurihara, Tokyo (JP)

(73) Assignee: MITSUBISHI HEAVY INDUSTRIES, LTD., Tokyo (JP)

(21) Appl. No.: 13/795,255

(22) Filed: Mar. 12, 2013

(30) Foreign Application Priority Data
Apr. 4, 2012 (JP) 2012-085076

(51) Int. Cl. H01M 4/78

(52) U.S. Cl. CPC H01M 4/78
USPC 429/163

(57) ABSTRACT

A battery includes a first electrode plate including a substantially rectangular first coating portion, and a first electrode tab connected to the first coating portion; a second electrode plate including a substantially rectangular second coating portion, and a second electrode tab connected to the second coating portion; a separator arranged between the first electrode plate and the second electrode plate; and a battery container that houses the first electrode plate, the second electrode plate, and the separator. The first electrode tab has a first rectangular portion having a substantially rectangular shape, and a first triangular portion that is connected to the first rectangular portion and the first coating portion, and the first triangular portion has a substantially straight oblique side that extends from the middle of the first rectangular portion.

### BACKGROUND OF THE INVENTION

1. Field of the Invention

The present invention relates to a battery, particularly a battery with improved performance. Priority is claimed on Japanese Patent Application No. 2012-085076, filed Apr. 4, 2012, the content of which is incorporated herein by reference.

2. Description of Related Art

Primary batteries that perform only discharging and secondary batteries capable of being charged and discharged are known in batteries. These batteries have a configuration (refer to Japanese Patent Application, First Publication No. 2011-108534 and Japanese Patent Application, First Publication No. 2009-123583) in which a stacked electrode body in which electrode plates, that is, a positive electrode plate and a negative electrode plate are stacked via a separator are sealed by a battery container, and are generally used for power supply for electric power load driving of a motor in a battery system or the like.

### SUMMARY OF THE INVENTION

However, in the battery of Japanese Patent Application, First Publication No. 2011-108534, in a case where the battery is charged or discharged, the temperature becomes high in the vicinity where a coating portion and an electrode tab (that is, a positive electrode tab or a negative electrode tab) of an electrode plate (that is, the positive electrode plate or the negative electrode plate) are connected. As a result, an electrode active material may deteriorate.

On the other hand, in the battery of Japanese Patent Application, First Publication No. 2009-123583, an electrode tab is present in the overall width of a coating portion. Therefore, a situation in which the temperature becomes high in the vicinity where the coating portion and the electrode tab are connected is avoided. However, since the shape of the electrode tab is triangular or trapezoidal, it is necessary to arrange a separator that is excessively larger than the dimension of the coating portion so that the positive electrode tab and the negative electrode tab overlap each other and are not short-circuited. As a result, the costs of the battery may rise. Additionally, since the shape of the electrode tab is the triangular or trapezoidal shape, the routing when the electrode tab is connected to the electrode terminal or the like may not be easy, and trouble may occur even in alignment during the connection.

Thus, an object of the invention is to simultaneously solve the above-mentioned problems with simple configuration, and provide a battery with improved battery performance.

In order to achieve the above object, a battery of the present invention includes a first electrode plate including a substantially rectangular first coating portion, and a first electrode tab connected to the first coating portion; a second electrode plate including a substantially rectangular second coating portion, and a second electrode tab connected to the second coating portion; a separator arranged between the first electrode plate and the second electrode plate; and a battery container that houses the first electrode plate, the second electrode plate, and the separator. The first electrode tab has a first rectangular portion having a substantially rectangular shape, and a first triangular portion that is connected to the first rectangular portion and the first coating portion, and the first triangular portion has a substantially straight oblique side that extends from the middle of the first rectangular portion.

That is, since the electrode tab of the battery of the invention is equipped with the rectangular portion and the triangular portion, the above routing and alignment can be facilitated by the rectangular portion, a region that becomes high temperature can be kept away from the coating portion by the triangular portion, and deterioration of the electrode active material can be prevented.

According to the battery of the present invention, it is possible to provide a battery that simultaneously prevents the above problems to improve the battery performance.

### BRIEF DESCRIPTION OF THE DRAWINGS

FIG. 1 is schematic views of a battery of an embodiment of the invention, with

FIG. 1(a) being a perspective view of the battery as viewed from an X-Z plane, and FIG. 1(b) being a Y-Z cross-sectional view in line A-A′ of FIG. 1(a).

FIG. 2 is schematic views of an electrode plate of FIG. 1, with FIG. 2(a) being a schematic view of a positive electrode plate, and FIG. 2(b) being a schematic view of a negative electrode plate.

FIG. 3 is schematic views illustrating respective high-temperature portions of a positive electrode plate and a negative electrode plate to be used for the battery of FIG. 1, with FIG. 3(a) being a schematic view of an electrode plate equipped with electrode tabs to be used in the battery of FIG. 1, and FIG. 3(b) being a schematic view of an electrode plate, to illustrate a comparison with the electrode plate that has no triangular portions.

FIG. 4 is schematic views of triangular portions of the positive electrode plate to be used for the battery of FIG. 1, with FIG. 4(a) being a schematic view of a triangular portion of the positive electrode plate, and FIG. 4(b) being a schematic view of a configuration to be illustrated in comparison with the triangular portion.

### DETAILED DESCRIPTION OF THE INVENTION

The battery of the present invention has one feature that an electrode tab of a electrode plate, in which an electrode active material is coated on a base material, includes a rectangular portion having a substantially rectangular shape, and a triangular portion that is connected to the rectangular portion and the coating portion, and has a substantially straight oblique side that extends from the middle of the rectangular portion. Hereinafter, a battery of an embodiment will be described in more detail by referring to the drawings.

In addition, as the battery of the embodiment, it is possible to use any batteries, such as a primary battery or a secondary battery. However, description will be made here using a lithium-ion secondary battery that is a chargeable and dischargeable battery, for example, a storage battery, as an example of the battery.

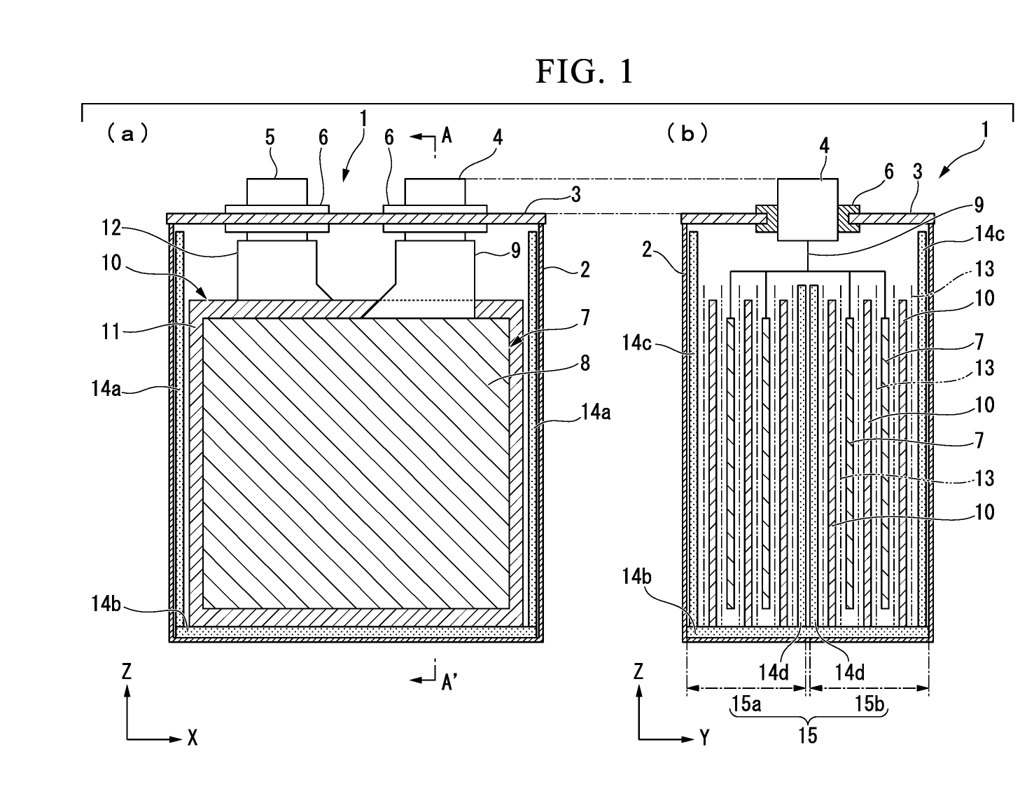

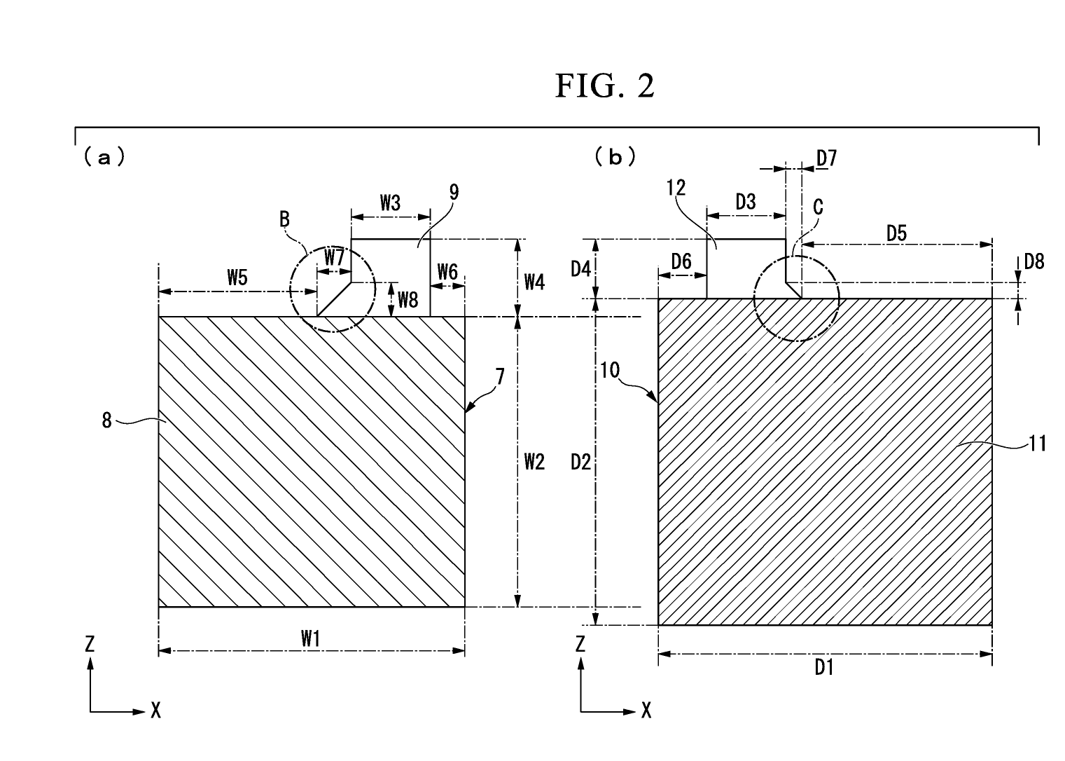

The battery 1 of the present embodiment will be described referring to FIG. 1 and FIG. 2. FIG. 1(a) is a perspective schematic view from the front face (X-Z plane) of the battery 1, and FIG. 1(b) is a cross-sectional schematic view in a Y-Z plane of line A-A′ of FIG. 1(a). In addition, the same orthogonal coordinate system is used in the views used below. Additionally, since FIG. 1(a) is a schematic view for easy understanding, not all of respective components shown in FIG. 1(b) will be described.

First, the battery 1 is equipped with an angular conductive (for example, made of metal, such as aluminum) container body 2 having a bottom face of a substantially rectangular shape on an X-Y plane and extends in a Z-axis direction from all the sides of the substantially rectangular shape, stacked electrode bodies 15 that are housed in the container body 2, and have positive electrode plates 7 and negative electrode plates 10 stacked via a separators 13, resin plates 14 (that is, resin plates 14a to 14d) that prevents the stacked electrode bodies 15 from coming into contact with the container body 2, and a lid 3 that seals the container body 2 after the stacked electrode bodies 15 are housed in the container body 2 (the container body 2 and the lid 3 are sealed by laser welding or the like to become a “battery container”). In addition, although not shown, an electrolytic solution or an electrolyte is stored in the battery container.

Here, the lid 3 is the same conductive material as the container body 2. The lid 3 is formed with, for example, columnar electrode terminals (a positive electrode terminal 4 and a negative electrode terminal 5) that are arranged through the lid 3, and an insulating resin 6 that fixes the electrode terminals to the lid 3 and electrically insulates the electrode terminals from the lid 3.

The stacked electrode bodies 15 (here, two stacked electrode bodies 15a and 15b) will be described below as being stacked type stacked electrode bodies in which a plurality of positive electrode plates 7 and a plurality of negative electrode plates 10 are sequentially stacked via separators 13 as an example.

The positive electrode plate 7 is punched and formed after a positive electrode active material, such as lithium manganate, is coated on both faces of foil of positive electrode metal (hereinafter referred to as a “positive electrode base material”), such as aluminum. The positive electrode plate 7 is equipped with a substantially rectangular portion (hereinafter referred to as “positive electrode coating portion” 8) in which the positive electrode active material is coated on the positive electrode base material, and a portion (hereinafter referred to as a “positive electrode non-coating portion”) in which the positive electrode active material is not coated on the positive electrode base material. A positive electrode tab 9 to be described below is the positive electrode non-coating portion.

The positional relationship between the positive electrode tab 9 and the positive electrode coating portion 8 is as shown in FIG. 2(a).

That is, the positive electrode coating portion 8 has a substantially rectangular shape of a dimension “W1” in an X direction and a dimension “W2” in a Z direction. Additionally, the positive electrode tab 9 has a substantially rectangular portion (hereinafter referred to as a “positive electrode rectangular portion”) including two sides of a dimension “W3” in the X direction and two sides of a dimension “W4” in the Z direction, and a substantially right-angled triangular portion (hereinafter a “positive electrode triangular portion”) including a side of a dimension “W7” in the X direction and a dimension “W8” in the Z direction, has a right angle between these two sides, and includes a substantially straight oblique side.

However, the segments of the positive electrode rectangular portion and the positive electrode triangular portion are convenient for only describing the shape of the positive electrode tab 9. That is, since these portions are formed by punching the same positive electrode base material, these portions are not separated from each other from the beginning. Of course, these portions may be physically and electrically connected by welding or the like after being formed as separate bodies according to design. Hereinafter, the cases of the “connection” among the positive electrode rectangular portion, the positive electrode triangular portion, and the positive electrode coating portion 8 include both a case where these portions are integrally formed originally from the beginning in this way and a case where these portions are integrally formed by welding or the like after being formed as separate bodies.

The positive electrode tab 9 has such a shape that the positive electrode rectangular portion and the positive electrode triangular portion are integrally connected so as not to overlap each other as viewed from the X-Z plane.

Specifically, the side, which is present in a −X direction, of the two sides of the above dimension “W4” of the positive electrode rectangular portion, and the side of the above dimension “W8” of the positive electrode triangular portion are located at positions on the same X axis, and the side of the above dimension “W7” of the positive electrode triangular portion is located at a position on the same Z axis as the side, which is present in a +Z direction, of the two sides of the positive electrode coating portion 8 that extend in the X direction.

In a case where a virtual line (hereinafter referred to as a “positive electrode virtual line”) is drawn in the Z direction from the center of the width of the positive electrode coating portion 8 in the X direction, the positive electrode tab 9 is located closer to a +X direction than the positive electrode virtual line, is located inside the positive electrode coating portion 8 in the X direction, and is connected to and integrated with the positive electrode coating portion 8 (accordingly, 0<(W3+W6+W7)<{(W1)÷2} is established). Additionally, the positive electrode triangular portion is arranged so as to be located closer to the positive electrode virtual line than the positive electrode rectangular portion on the X-axis. In addition, here, a dimension “W5” in FIG. 2(a) is the distance in the X direction from the side, which is located in the −X direction, of the two sides of the positive electrode coating portion 8 that extend in the Z direction, to the positive electrode tab 9, and a dimension “W6” is the distance in the X direction from the side, which is located in the +X direction, of the two sides of the positive electrode coating portion 8 that extend in the Z direction, to the positive electrode tab 9. Hence, W1=W3+W5+W6+W7 is established.

On the other hand, the negative electrode plate 10 is punched and formed after a negative electrode active material, such as carbon, is coated on both faces of the foil of the negative electrode metal (hereinafter referred to as a “negative electrode base material”), such as copper. The negative electrode plate 10 is equipped with a substantially rectangular portion (hereinafter referred to as “negative electrode coating portion” 11) in which the negative electrode active material is coated on the negative electrode base material, and a substantially rectangular portion (hereinafter referred to as a “negative electrode non-coating portion”) in which the negative electrode active material is not coated on the negative electrode base material. A negative electrode tab 12 to be described below is the negative electrode non-coating portion.

The positional relationship between the negative electrode tab 12 and the negative electrode coating portion 11 is as shown in FIG. 2(b).

That is, the negative electrode coating portion 11 has a substantially rectangular shape of a dimension “D1” in the X direction and a dimension “D2” in the Z direction.

Additionally, the negative electrode tab 12 has a substantially rectangular portion (hereinafter referred to as a “negative electrode rectangular portion”) including two sides of a dimension “D3” in the X direction and a dimension “D4” in the Z direction, and a substantially right-angled triangular portion (hereinafter a “negative electrode triangular portion”) including a side of a dimension “D7” in the X direction and a dimension “W8” in the Z direction, has a right angle between these two sides, and includes a substantially straight oblique side.

However, the negative electrode rectangular portion and the negative electrode triangular portion are convenient segment for just describing the shape of the negative electrode tab 12. Similarly to the case of the positive electrode tab 9, since these portions are formed by punching the same negative electrode base material, these portions are not separated from each other from the beginning. Of course, these portions may be physically and electrically connected by welding or the like after being formed as separate bodies according to design. Hereinafter, the cases of the “connection” among the negative electrode rectangular portion, the negative electrode triangular portion, and the negative electrode coating portion 11 include both a case where these portions are integrally formed originally from the beginning in this way and a case where these portions are integrally formed by welding or the like after being formed as separate bodies.

The negative electrode tab 12 has such a shape that the negative electrode rectangular portion and the negative electrode triangular portion are integrally connected so as not to overlap each other when viewed from the X-Z plane.

Specifically, the side, which is present in the +X direction, of the two sides of the above dimension “D4” of the negative electrode rectangular portion, and the side of the above dimension “D8” of the negative electrode triangular portion are located at positions on the same X axis, and the side of the above dimension “D7” of the negative electrode triangular portion is located at a position on the same Z axis as the side, which is present in the +Z direction, of the two sides of the negative electrode coating portion 11 that extend in the X direction.

In a case where a virtual line (hereinafter referred to as a “negative electrode virtual line”) is drawn in the Z direction from the center of the width of the negative electrode coating portion 11 in the X direction, the negative electrode tab 12 is located closer to the −X direction than the negative electrode virtual line, is located inside the negative electrode coating portion 11 in the X direction, and is connected to and integrated with the negative electrode coating portion 11 (accordingly, 0<(D3+D6+D7)<{(D1)÷2} is established). Additionally, the negative electrode triangular portion is arranged so as to be located closer to the negative electrode virtual line than the negative electrode rectangular portion on the X-axis. In addition, here, a dimension “D5” in FIG. 2(a) is the distance in the X direction from the side, which is located in the +X direction, of the two sides of the negative electrode coating portion 11 that extend in the Z direction, to the negative electrode tab 12, and a dimension “D6” is the distance in the X direction from the side, which is located in the -X direction, of the two sides of the negative electrode coating portion 11 that extend in the Z direction, to the negative electrode tab 12. Hence, D1=D3+D5+D6+D7 is established.

The dimension of the substantially rectangular shape of the negative electrode coating portion 11 in the X-Z plane is smaller than such a dimension that the negative electrode coating portion is housed inside the battery container without bending, that is, the internal diameter of the battery container in the X-Z plane. The dimensions of the substantially rectangular shape of the negative electrode coating portion 11 in the X-Z plane is larger than the dimensions of the substantially rectangular shape of the positive electrode coating portion 8 in the X-Z plane. That is, 0<W1<D1 and 0<W2<D2 are established.

Accordingly, as shown in FIG. 1(a), as viewed from the Y direction, the positive electrode coating portion 8 is arranged within the face of the negative electrode coating portion 11. Additionally, since the positive electrode virtual line and the negative electrode virtual line are substantially aligned with each other on the X-Z plane and the positive electrode plate 7 and the negative electrode plate 10 are sequentially stacked in the Y direction via the separator, the negative electrode tab 12 is arranged at a position that does not overlap the positive electrode tab 9 on the X-Z plane. Therefore, since the positive electrode tab 9 and the negative electrode tab 12 has no mutually overlapping positional relationship, the dimension of the separator 13 to be described below may be substantially equal to the dimension of the coating portions of the electrode plates. Accordingly, unlike the battery of Japanese Patent Application, First Publication No. 2009-123583, the battery 1 can be economically manufactured from the viewpoint of the quantity of separators.

In the present embodiment, the separator 13 is formed as a bag-shaped separator, as shown in FIG. 1(b). Here, a state where the whole coating portion surface (here, the whole surface of the negative electrode coating portion 11) of an electrode plate is stored inside the bag-shaped separator, and an electrode tab (here, the negative electrode tab 12) is sticking out of the inside of the bag to the outside is referred to “encapsulation”.

By forming the separator 13 into a bag shape, the negative electrode plate 10 is sufficiently prevented from coming into contact with the positive electrode plate 7.

Of course, in a case where such a preventing function can be achieved by adjusting the dimension of the separator or the like, the separator is not necessarily formed into a bag shape. Accordingly, the shape of the separator may be simply a substantially rectangular sheet shape.

Then, stacking is started from the negative electrode plate 10 encapsulated by the bag-shaped separator 13, the positive electrode plate 7 is stacked on (+Y direction) the separator 13 of the negative electrode plate 10, and then, the negative electrode plate 10 encapsulated by the bag-shaped separator 13 is stacked on (+Y direction) the positive electrode plate 7. In this case, the plurality of the negative electrode plates 10 to be stacked are arranged such that the positions of the respective negative electrode tabs 12 in the X-Z plane are aligned. Additionally, the plurality of positive electrode plates 7 to be stacked are arranged such that the positions of the respective positive electrode tabs 9 in the X-Z plane are aligned.

This is sequentially repeated, eventually forming the stacked electrode bodies 15 including the plurality of positive electrode plates 7 and the plurality of negative electrode plates 10 and having the negative electrode plates 10 arranged at both ends in the Y direction when viewed from the X direction.

Then, the stacked electrode bodies 15 are sandwiched from the Y direction by the substantially rectangular insulating resin plates 14c and 14d, and are inserted into the container body 2 while being sandwiched from the X direction by the two substantially rectangular insulating resin plates 14a. For this reason, since these resin plates become insertion guides, when the stacked electrode bodies 15 are inserted into the container body 2, any damage such that an electrode plate is deformed by striking the container body 2 can be prevented.

Additionally, the substantially rectangular insulating the resin plate 14b of substantially the same dimension as the bottom face of the container body 2 is arranged with this bottom face. Accordingly, the stacked electrode bodies 15 are prevented from being electrically connected to the container body 2.

In addition, the resin plate 14 is made of resin, such as polypropylene, and has a thickness of, for example, about 0.5 mm.

Incidentally, all the positive electrode tabs 9 that are aligned at substantially the same position as viewed from the Y direction are physically and electrically connected to the positive electrode terminal 4 by riveting or welding. For this reason, in order to facilitate routing or alignment of the positive electrode tab 9, it is necessary for W8<<W4. In addition, in this case, although a metallic lead for a positive electrode may be interposed between the positive electrode tab 9 and the positive electrode terminal 4, it is necessary for W8<<W4 even in this case.

Accordingly, if the shape of the positive electrode tab 9 is described in a way different from the above description, it can be said that the portion connected to the positive electrode terminal 4 or the lead for a positive electrode has a substantially rectangular plate shape, and there is provided a shape including a portion that is wide toward an end at a substantially straight inclination toward the direction of the positive electrode virtual line from the middle of the substantially rectangular plate-shaped portion that extends from the portion concerned to the positive electrode coating portion 8.

Additionally, all the negative electrode tabs 12 that are aligned substantially at the same position as viewed from the Y direction are physically and electrically connected to the negative electrode terminal 5 by riveting or welding. For this reason, in order to facilitate routing or alignment of the negative electrode tab 12, it is necessary for D8<<D4. In addition, in this case, although a metallic lead for a negative electrode may be interposed between the negative electrode tab 12 and the negative electrode terminal 5, it is necessary for D8<<D4 even in this case.

Accordingly, if the shape of the negative electrode tab 12 is described in a way different from the above description, it can be said that the portion connected to the negative electrode terminal 5 or the lead for a negative electrode has a substantially rectangular plate shape, and there is provided a shape including a portion that spreads wide toward an end at a substantially straight inclination toward the direction of the negative electrode virtual line from the middle of the substantially rectangular plate-shaped portion that extends from the portion concerned to the negative electrode coating portion 11.

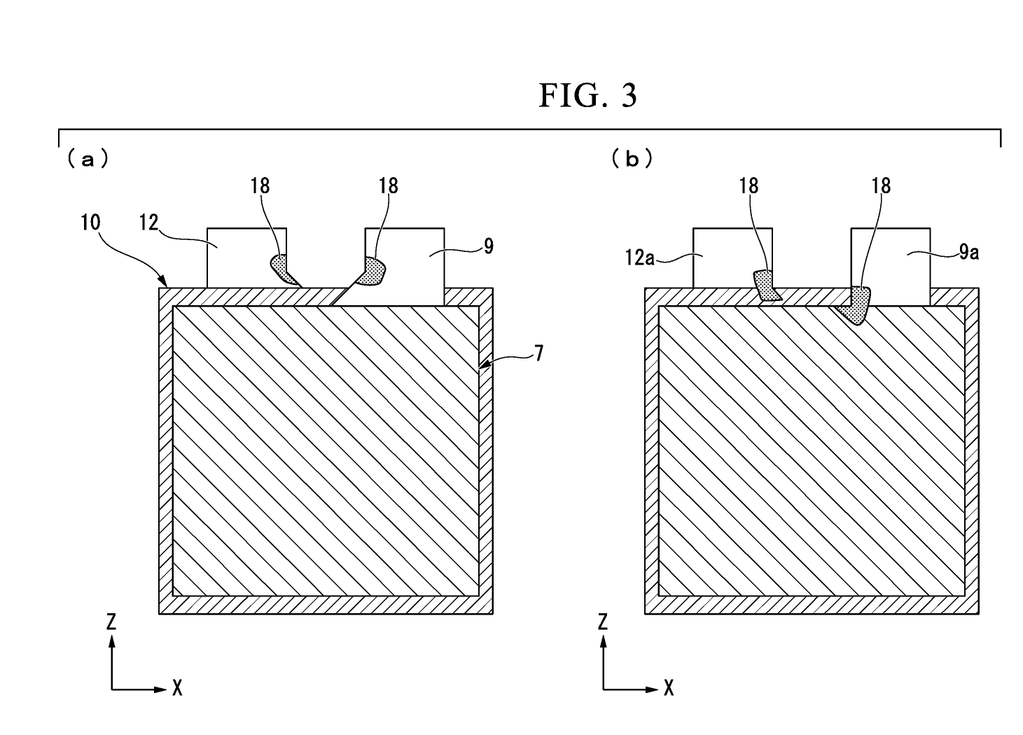

Then, one of the effects of the battery 1 of the present embodiment will be described in detail. In the battery 1, not only the rectangular portions (that is, the positive electrode rectangular portions or the negative electrode rectangular portions) but also the triangular portions (that is, the positive electrode triangular portions and the negative electrode triangular portions) are present in the electrode tabs (that is, the positive electrode tabs 9 and the negative electrode tabs 12). It is thereby possible to prevent heat from being accumulated at the boundaries between the electrode tabs and the coating portions (that is, the positive electrode coating portions 8 or the negative electrode coating portions 11), and to prevent the coated electrode active material from deteriorating due to heat. This point will be described using FIG. 3.

First, for easy understanding, a case where these triangular portions are not formed is shown in FIG. 3(b), and is compared with the battery 1 of the present embodiment. As shown in FIG. 3(b), in a case where a battery in which the triangular portions are removed from the electrode plates of FIG. 3(a) is charged or discharged, a high-temperature portion 18 of a positive electrode plate is present so as to enter a positive electrode coating portion in the vicinity of a region nearest to a positive electrode virtual line in a region that connects a positive electrode tab 9a and the positive electrode coating portion. Additionally, a high-temperature portion 18 of a negative electrode plate is present so as to enter a negative electrode coating portion, near a region nearest to a negative electrode virtual line in a region that connects a negative electrode tab 12a and the negative electrode coating portion. Although being also dependent on the magnitude of the value of a current value to be charged or discharged, generally, these high-temperature portions 18 have a temperature that is several degrees higher than a portion with the lowest temperature of each electrode plate. Accordingly, since the high-temperature portion 18 that has the highest temperature in the electrode plate is present in the coating portion, a difference may be caused in the temperature of the electrode active material depending on regions of the coating portion, and thereby, the electrode active material of the high-temperature portion 18 may deteriorate. As a result, the battery performance may deteriorate.

On the other hand, according to the battery 1 of the present embodiment, as shown in FIG. 3(a), a high-temperature portion 18 of the positive electrode plate 7 is present near a region (that is, a region that begins to spread wide toward the end in the positive electrode tab 9) where the angle outside the positive electrode tab 9 formed by the positive electrode rectangular portion and the positive electrode triangular portion becomes an obtuse angle, in a region nearest to the +Z side in a region where the positive electrode rectangular portion and positive electrode triangular portion of the positive electrode tab 9 are connected. Additionally, a high-temperature portion 18 of the negative electrode plate 10 is present near a region (that is, a region that begins to spread wide toward the end in the negative electrode tab 12) where the angle outside the positive electrode tab 12 formed by the negative electrode rectangular portion and the negative electrode triangular portion becomes an obtuse angle, in a region nearest to the +Z side in a region where the negative electrode rectangular portion and negative electrode triangular portion of the negative electrode tab 12 are connected.

Accordingly, the high-temperature portion 18 of the positive electrode plate 7 is not present in a positive electrode coating portion, and the high-temperature portion 18 of the negative electrode plate 10 is not present in the negative electrode coating portion. Hence, each electrode active material can be prevented from deteriorating, and as a result, the battery performance can be prevented from deteriorating.

If dimension are designed so that the high-temperature portion 18 of the positive electrode tab 9 does not overlap the negative electrode coating portion of the negative electrode plate 10 particularly when the positive electrode plate 7 and the negative electrode plate 10 are stacked as described above, deterioration of the battery performance can be more effectively prevented.

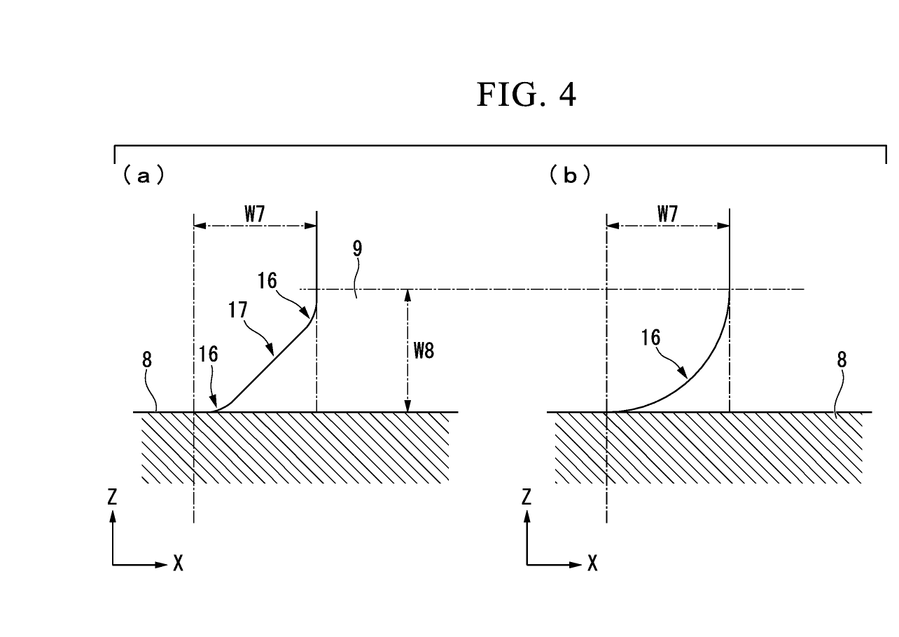

Here, it is desirable that the shape of the above substantially straight inclination of the positive electrode triangular portion, as shown in FIG. 4(b) where a portion shown by one-dot chain line 13 of FIG. 2(a) is enlarged, be a shape that includes a straight portion 17 and curved portions 16 at both ends of the straight portion, and has one of the curved portions 16 smoothly connected to the positive electrode coating portion and the other of the curved portions 16 smoothly connected to the positive electrode rectangular portion. By adopting the configuration of being smoothly connected by the curved portions, generation of burrs or the like during the above punching of the electrode plates can be prevented.

Additionally, in order to enlarge a current path, it is desirable to create a design so that W7 is made as large as possible in a range of W3+W6+W7<{(W1)÷2}, and as W7≦W8, the area of the positive electrode triangular portion is made as large as possible and the high-temperature portion 18 is further away from the positive electrode coating portion. If the positive electrode triangular portion is a substantially rectangular isosceles triangle, a design that satisfies these requirements is easy to produce.

In addition, since the shape of the above straight inclination of the positive electrode triangular portion has only to be a substantially straight line, the shape of the inclination may not be a shape that has both the straight portion 17 and the curved portion 16, for example, may be a circular arc with a diameter dimension R1. However, if R1=2×(W7) is established in the curved portion 16 as shown in FIG. 4(b), battery deterioration may occur because area decreases more significantly than the positive electrode triangular portion shown in FIG. 4(a). Accordingly, it is necessary to adopt a substantially straight shape as R1>>2×(W7).

The same is true in the shape of the substantially straight inclination of the negative electrode triangular portion. That is, it is desirable that a portion shown by one-dot chain line C of FIG. 2(b), similarly to the positive electrode triangular portion, also has a shape that includes a straight portion and curved portions at both ends of the straight portion, and has one of the curved portions smoothly connected to the negative electrode coating portion and the other of the curved portions smoothly connected to the negative electrode rectangular portion.

Additionally, in order to enlarge a current path, it is desirable to create a design so that D7 is made as large as possible in a range of D3+D6+D7<{(D1)÷2}, and as D7≦D8, the area of the positive electrode triangular portion is made as large as possible and the high-temperature portion 18 is further away from the negative electrode coating portion. If the negative electrode triangular portion is a substantially rectangular isosceles triangle, a design that satisfies these requirements is easy.

In addition, since the shape of the above straight inclination of the negative electrode triangular portion, similarly to the positive electrode triangular portion, has only to be a substantially straight line, the shape of the inclination may be, for example, a circular arc with a diameter dimension R2. However, it is necessary to adopt a substantially straight shape where R2>>2×(D7).

As described above, according to the battery 1 of the present embodiment, deterioration of the electrode active material caused by temperature can be prevented by the electrode tabs being equipped with the triangular portions, and the excellent battery 1 with easy routing or the like of the electrode tabs can be provided by the electrode tabs being equipped with the rectangular portions.

For example, in the case of W1=97 mm, W2=130 mm, W3=30 mm, W4=20 mm, W5=49 mm W6=10 mm, W7=8 mm, W8=8 mm, D1=100 mm D2=135 mm, D3=30 mm, D4=20 mm, D5=52 mm, D6=10 mm, D7=8 mm, and D8=8 mm, excellent results was obtained by simulation.

Additionally, in addition to these dimensions, excellent results were obtained even in a case where simulation was performed as R1=4×(W7)=32 mm and R2=4×(D7)=32 mm. Therefore, if R1≧4×(W7) and R2≧4×(D7) are satisfied, it can be said that these circular arcs are substantially straight.

In addition, it is desirable that (W4)÷(W8)≧2.5 and (D4)÷(D8)≧2.5 are satisfied from a viewpoint of facilitating the above routing or the like.

The invention is not limited to the above described embodiment and modifications thereof, or combinations thereof, and various alternations can be made without departing from the spirit of the invention. In the above description, a configuration in which the electrode tabs of both the positive electrode plate and the negative electrode plate is equipped with the triangular portion is described. However, a configuration in which the electrode tab of only one electrode plate is equipped with the triangular portion may be adopted. For example, in a case where only any one high-temperature portion becomes a pending question by the combination of the positive electrode active material and the negative electrode active material, a configuration in which only one electrode plate is equipped with the triangular portion may be adopted and the configuration shown in FIG. 3(b) may be adopted as the other electrode plate.

Additionally, although the shape of the battery container has been described as an angular type, the shape of the battery container may be a cylindrical type. Although the battery container is conductive in the above description, the battery container may be formed from insulating materials, such as plastic resin. In this case, the resin 6 and the resin plates 14 become unnecessary.

Moreover, the stacked electrode bodies 15 may be stacked electrode bodies (stacked type stacked electrode bodies) in which a plurality of positive electrode plates and a plurality of negative electrode plates are sequentially stacked via separators, or may be a stacked electrode body (wound type stacked electrode body) in a state where one positive electrode plate and one negative electrode plate are stacked and wound via one separator. In addition, in a case where the stacked electrode bodies 15 are the stacked type stacked electrode bodies, the number of the positive electrode plates 7 and the negative electrode plates 10 can be one or more, that is, can be appropriately designed as a plurality of pieces.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A battery comprising:
a first electrode plate including a substantially rectangular first coating portion, and a first electrode tab connected to the first coating portion;
a second electrode plate including a substantially rectangular second coating portion, and a second electrode tab connected to the second coating portion;
a separator arranged between the first electrode plate and the second electrode plate; and
a battery container that houses the first electrode plate, the second electrode plate, and the separator, wherein
the first electrode tab has a first rectangular portion having a substantially rectangular shape, and a first triangular portion that is connected to the first rectangular portion and the first coating portion and, the first triangular portion has a substantially straight oblique side that extends from the middle of the first rectangular portion.

2. The battery according to claim 1, wherein
the first electrode tab and the second electrode tab are configured to not overlap each other.

3. The battery according to claim 2, wherein
the second electrode tab has a second rectangular portion having a substantially rectangular shape, and a second triangular portion that is connected to the second rectangular portion and the second coating portion, and the second triangular portion has a substantially straight oblique side that extends from the middle of the second rectangular portion.

4. The battery according to claim 3, wherein
the first electrode plate is a positive electrode plate, and the second electrode plate is a negative electrode plate.

5. The battery according to claim 4, wherein
the straight oblique side of the first and second triangular portions are circular arcs.
